(19) United States
(12) Patent Application Publication
(10) Pub. No.: US 2021/0224442 A1
(43) Pub. Date: Jul. 22, 2021

(54) SIMULATION APPARATUS, SIMULATION METHOD, AND COMPUTER READABLE MEDIUM STORING PROGRAM

(71) Applicant: SUMITOMO HEAVY INDUSTRIES, LTD., Tokyo (JP)

(72) Inventor: Yoshitaka Kobayashi, Kanagawa (JP)

(21) Appl. No.: 17/137,815

(22) Filed: Dec. 30, 2020

(30) Foreign Application Priority Data
Jan. 21, 2020 (JP) 2020-007534

(51) Int. Cl. G06F 30/28; G06F 30/25

(52) U.S. Cl. CPC G06F 30/28; G06F 30/25

(57) ABSTRACT

In a simulation apparatus, simulation conditions including information defining a shape of a flow path wall surface, information defining an interaction potential that a fluid particle receives from the wall surface, and physical properties of a fluid are input. A processing unit solves a motion equation for the fluid particle based on the simulation conditions to temporally develop a position of the fluid particle. The processing unit measures the fluid particle having a predetermined distance or shorter to the wall surface as a wall surface proximity particle, and generates plural virtual particles at positions for interaction with the wall surface proximity particle. The positions of the virtual particles are fixed, and an interaction potential preventing parallel movement of the wall surface proximity particle to the wall surface is applied between the wall surface proximity particle and the virtual particles, to solve the motion equation for the wall surface proximity particle.

### RELATED APPLICATIONS

The content of Japanese Patent Application No. 2020-007534, on the basis of which priority benefits are claimed in an accompanying application data sheet, is in its entirety incorporated herein by reference.

### BACKGROUND

### Technical Field

Certain embodiments of the present invention relate to a simulation apparatus, a simulation method, and a computer readable medium storing a program for analyzing a fluid flow.

### Description of Related Art

The related art discloses a technique for analyzing a flow of a fluid in contact with a wall surface using a molecular dynamics method. Experiments have shown that it is proper that an average velocity of the fluid is zero at a position in contact with the wall surface (wall surface boundary). In the method disclosed in the related art, mirror boundary conditions are applied at the wall surface boundary, and the velocity of particles is reset so that the average velocity of the fluid in a tangential direction on the wall surface becomes zero.

### SUMMARY

According to an embodiment of the present invention, there is provided a simulation apparatus that analyzes behaviors of a plurality of fluid particles in an analysis model in which a fluid in contact with a wall surface is represented by the plurality of fluid particles, the apparatus including: an input unit through which simulation conditions including information that defines a shape of the wall surface, information that defines an interaction potential that the plurality of fluid particles receive from the wall surface, and physical property values of the fluid are input; and a processing unit that acquires the simulation conditions input through the input unit, solves an equation of motion for the plurality of fluid particles on the basis of the acquired information, and develops positions of the plurality of fluid particles over time. The processing unit measures a fluid particle whose distance to the wall surface is equal to or less than a proximity determination threshold value among the plurality of fluid particles as a wall surface proximity particle, and generates a plurality of virtual particles at positions where the plurality of virtual particles interact with the wall surface proximity particle, fixes the positions of the plurality of virtual particles, and causes an interaction potential that prevents movement of the wall surface proximity particle in a direction parallel to the wall surface to act between the wall surface proximity particle and the plurality of virtual particles to solve the equation of motion for the wall surface proximity particle.

According to another embodiment of the invention, there is provided a simulation method for analyzing behaviors of a plurality of fluid particles in an analysis model in which a fluid in contact with a wall surface is represented by the plurality of fluid particles, the method including: acquiring simulation conditions including information that defines a shape of the wall surface, information that defines an interaction potential that the plurality of fluid particles receive from the wall surface, and physical property values of the fluid; solving an equation of motion for the plurality of fluid particles on the basis of the acquired information to analyze behaviors of the plurality of fluid particles; measuring a fluid particle whose distance to the wall surface is equal to or less than a proximity determination threshold value among the plurality of fluid particles as a wall surface proximity particle, during the analysis; and generating a plurality of virtual particles at positions where the plurality of virtual particles interact with the measured wall surface proximity particle, fixing the positions of the plurality of virtual particles, and causing an interaction potential that prevents movement of the wall surface proximity particle in a direction parallel to the wall surface to act between the wall surface proximity particle and the plurality of virtual particles to solve the equation of motion for the wall surface proximity particle.

According to still another embodiment of the invention, there is provided a computer readable medium storing a program that causes a computer to execute a simulation that analyzes behaviors of a plurality of fluid particles in an analysis model in which a fluid in contact with a wall surface is represented by the plurality of fluid particles, the program causing the computer to realize: a function of acquiring simulation conditions including information that defines a shape of the wall surface, information that defines an interaction potential that the plurality of fluid particles receive from the wall surface, and physical property values of the fluid; a function of solving an equation of motion for the plurality of fluid particles on the basis of the acquired information to analyze behaviors of the plurality of fluid particles; a function of measuring a fluid particle whose distance to the wall surface is equal to or less than a proximity determination threshold value among the plurality of fluid particles as a wall surface proximity particle, during the analysis; and a function of generating a plurality of virtual particles at positions where the plurality of virtual particles interact with the measured wall surface proximity particle, fixing the positions of the plurality of virtual particles, and causing an interaction potential that prevents movement of the wall surface proximity particle in a direction parallel to the wall surface to act between the wall surface proximity particle and the plurality of virtual particles to solve the equation of motion for the wall surface proximity particle.

### BRIEF DESCRIPTION OF THE DRAWINGS

FIG. 1 is a cross-sectional view including a center axis of a circular tube through which a fluid flows.

FIG. 2 is a block diagram of a simulation apparatus according to an embodiment.

FIG. 3A is a diagram showing an example of an analysis model of a simulation performed by the simulation apparatus according to the embodiment, FIG. 3B is a graph showing an example of an interaction potential acting between fluid particles, and FIG. 3C is a graph showing an example of an interaction potential exerted on the fluid particles by a wall surface.

FIG. 4 is a flowchart of a simulation method according to an embodiment.

FIG. 5 is a schematic diagram for explaining a signed distance function.

FIG. 6 is a flowchart showing a detailed process of step S4 (FIG. 4).

FIG. 7 is a schematic view showing a positional relationship between a wall surface and a fluid particle.

FIG. 8A is a diagram showing a positional relationship between a wall surface proximity particle and a plurality of virtual particles when viewed in a direction parallel to a perpendicular line drawn from the wall surface proximity particle to the wall surface, FIG. 8B is a diagram showing a positional relationship between the wall surface proximity particle and the plurality of virtual particles when viewed in a direction perpendicular to the perpendicular line drawn from the wall surface proximity particle to the wall surface, and FIG. 8C is a graph showing an interaction potential.

FIG. 9 is a graph showing a simulation result in a case where a flow of a power law fluid is simulated.

### DETAILED DESCRIPTION

When polymer was used as a fluid and a flow of the fluid was analyzed by applying the mirror boundary conditions described in the related art, it was found that particle slippage was observed at a wall surface boundary and a flow velocity did not become zero. A Kremer-Grest model was used for the analysis of the polymer particles.

It is desirable to provide a simulation apparatus, a simulation method, and a computer readable medium storing a program capable of performing an analysis that reflects an actual flow velocity distribution, in which a flow velocity on a wall surface becomes almost zero, even in analysis of a fluid made of polymer, or the like.

Before explaining embodiments, a flow velocity distribution in a circular tube of a fluid made of polymer will be described.

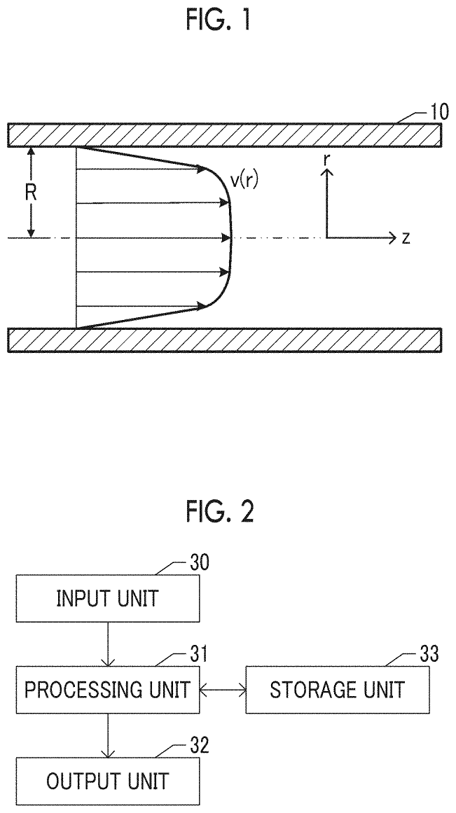

FIG. 1 is a cross-sectional view including a center axis of a circular tube 10 through which a fluid flows. A direction parallel to the center axis of the circular tube 10 is a z-axis direction, and a distance from the center axis is represented by r. An inner radius of the circular tube 10 is represented by R. In a polymer material, it is known that a relationship between a viscosity and a strain rate follows a power law. In a case where a shear stress of a power law fluid is represented by τ, a viscosity coefficient is represented by η₀, and a strain rate is represented by γ dot, the following equation is established.

$$τ = {η}_{0} \text{?} \\ \text{?} \text{indicates text missing or illegible when filed} \qquad ( 1 )$$

Here,

η₀|γ|ⁿ⁻¹ (2)

on the right side of Equation (1) is an apparent viscosity.
Here, n is a constant. In a Newtonian fluid, n is 1, and in a polymeric fluid, n is usually 1 or less.

There is a theoretical solution in a flow velocity distribution in a circular tube, and a velocity v (r) is expressed by the following equation.

$$v ( r ) = {v}_{0} \{ 1 - {( \frac{r}{R} )}^{\frac{n + 1}{n}} \} \\ {v}_{0} = \frac{n}{n + 1} {( \frac{ρ g}{2 {η}_{0}} )}^{\frac{1}{n}} \qquad ( 3 )$$

Here, ρ is the density of a fluid, g is an gravitational acceleration, and ρg is a body force. The velocity v (r) becomes maximum at the center of the circular tube (r=0), and becomes zero at a wall surface (r=R) of the circular tube.

In simulating a flow of the Newtonian fluid using a molecular dynamics method, in a case where a process of applying mirror boundary conditions to a wall surface boundary and resetting the velocity of particles so that a z-axis velocity of the fluid on a wall surface becomes zero, a velocity distribution obtained by the simulation becomes almost zero on the wall surface. However, in a case where a velocity distribution of the power law fluid in which the constant n in Equation (1) is 1 or less is obtained by simulation, it is known that the velocity on the wall surface does not become zero. In the embodiments described below, the velocity of particles on the wall surface becomes almost zero even in a simulation of a power law fluid such as polymer.

Next, a simulation apparatus and a simulation method according to an embodiment will be described with reference to FIGS. 2 to 8C.

FIG. 2 is a block diagram of the simulation apparatus according to the embodiment. The simulation apparatus according to the embodiment includes an input unit 30, a processing unit 31, an output unit 32, and a storage unit 33. Simulation conditions and the like are input through the input unit 30 to the processing unit 31. Further, various commands are input through the input unit 30 from an operator. The input unit 30 includes, for example, a communication device, a removable medium reader, a keyboard, and the like.

The processing unit 31 performs a simulation using the molecular dynamics method or a renormalization group molecular dynamics method (hereinafter, simply referred to as the molecular dynamics method) on the basis of input simulation conditions and commands. Further, the simulation result is output through the output unit 32. The simulation result includes information representing a state of particles of a particle system that is a simulation object, a temporal change of a physical quantity of the particle system, and the like. The processing unit 31 includes, for example, a central processing unit (CPU) of a computer. A program for causing the computer to execute the simulation by the molecular dynamics method is stored in the storage unit 33. The output unit 32 includes a communication device, a removable medium writing device, a display, and the like.

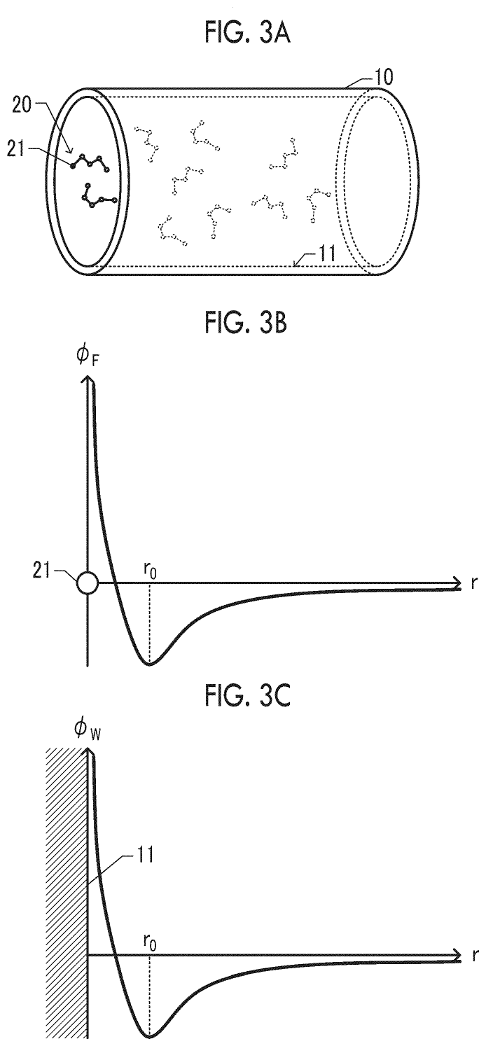

FIG. 3A is a diagram showing an example of an analysis model of a simulation performed by the simulation apparatus according to the embodiment. A fluid made of a polymer material that contacts an inner wall surface 11 of the circular tube 10 flows in the circular tube 10. The fluid is represented as an aggregate of a plurality of fluid particles 21. Several fluid particles 21 are combined to form one polymer 20. The fluid includes a plurality of polymers 20. The fluid particles 21 correspond to monomers that form the polymer 20.

In the analysis model shown in FIG. 3A, a behavior of the particle system made of of the polymers 20 is analyzed by the molecular dynamics method. Here, a force due to an interaction between the fluid particles 21, a force due to an interaction between the fluid particles 21 and the wall surface 11, and a body force given from the outside act on each of the fluid particles 21. Periodic boundary conditions are applied to end faces at both ends in the axial direction of the circular tube 10.

Next, the interaction between the fluid particles 21 will be described.

As an interaction potential φ_{F} (r) between the fluid particles 21, between arbitrary fluid particles 21, the following equation is applied.

$${φ}_{R} ( r ) = {U}_{F 0} ( r ) \qquad ( 4 )$$

Here, r represents a distance from the fluid particle 21.

A potential U_{F0} (r) is basically expressed by the following equation.

$${U}_{F 0} ( r ) = {ɛ}_{F} f ( \frac{r}{{σ}_{F}} ) \qquad ( 5 )$$

Here, f represents a dimensionless function, and ε_{F}and σ_{F} are fitting parameters that characterize the fluid particle 21. The fitting parameter ε_{F} has an energy dimension, and is called an interaction coefficient. The fitting parameter σ_{F} has a distance dimension, and depends on the size of particles. As the potential U_{F0} (r), for example, a Lennard-Jones type potential may be applied. Alternatively, a Morse-type potential may be applied.

FIG. 3B is a graph showing an example of the interaction potential φ_{F} (r) acting between the fluid particles 21. The potential decreases as the distance r increases in the vicinity of the fluid particle 21, and the potential shows a minimum value at a position where the distance r from the fluid particle 21 is r₀. In a range where the distance r from the fluid particle 21 is farther than r₀, the potential gradually increases as the distance r increases, and gradually approaches 0.

A finite elongation nonlinear elastic potential U_{ch} (r: ε_{F}, σ_{F}) is added to the potential U_{F0} (r) between the fluid particles 21 adjacent to each other in the same polymer 20, so that the following equation is applied.

$${φ}_{R} ( r ) = {U}_{F 0} ( r ) + {U}_{ch} ( \text{?} ) \\ \text{?} \text{indicates text missing or illegible when filed} \qquad ( 6 )$$

The finite elongation nonlinear elastic potential U_{ch} (r: ε_{F}, σ_{F}) includes parameters that depend on the fitting parameters ε_{F}and σ_{F} that define the potential U_{F0} (r).

Next, the interaction between the fluid particle 21 and the wall surface 11 will be described.

As the interaction potential φ_{W} (r) that the fluid particle 21 receives from the wall surface 11, the following equation is applied.

$${φ}_{w} ( r ) = {U}_{w 0} ( r ) \qquad ( 7 )$$

Like the potential U_{F0} (r), the potential U_{W0} (r) is basically expressed by the following equation.

$${U}_{W 0} ( r ) - {σ}_{W} f ( \frac{r}{{σ}_{W}} ) \qquad ( 8 )$$

Here, f represents a dimensionless function, and ε_{W} and σ_{W} are fitting parameters that characterize the wall surface 11. As the potential U_{W0} (r), for example, a Lennard-Jones type potential may be applied. Alternatively, a potential such that a repulsive force applied to the fluid particle 21 increases as it approaches the wall surface 11, for example, the Morse type potential may be applied.

FIG. 3C is a graph showing an example of the interaction potential φ_{W} (r) exerted on the fluid particles 21 by the wall surface 11. The shape of the interaction potential φ_{W} (r) is similar to the shape of the interaction potential φ_{F} (r). In this embodiment, the interaction potential φ_{W} (r) and the interaction potential φ_{F} (r) are the same. That is, the fitting parameters ε_{W} and σ_{W} of Equation (8) are equal to the fitting parameters ε_{F} and σ_{F} of Equation (5), respectively. Note that it is not essential that the fitting parameters ε_{W} and σ_{W} of Equation (8) should be equal to the fitting parameters ε_{F} and σ_{F} of Equation (5), respectively. Simulations may be performed under various conditions in which the fitting parameters ε_{W} and σ_{W} are different, and conditions in which an actual flow velocity distribution is best reflected may be adopted as the values of the fitting parameters ε_{W} and σ_{W}.

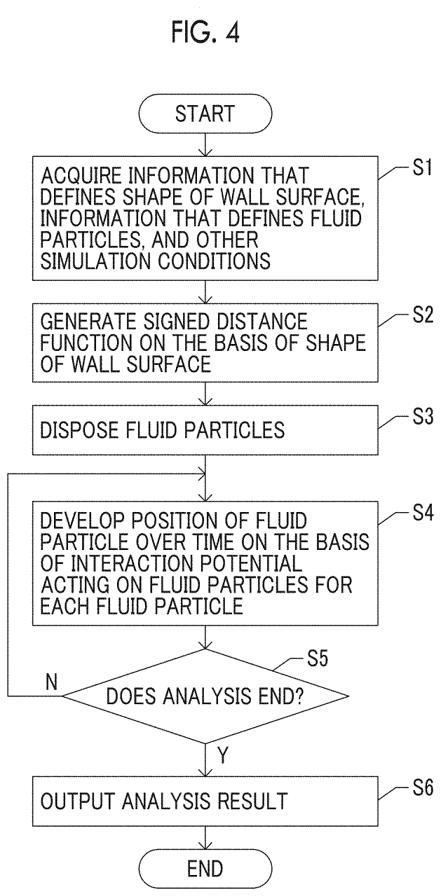

FIG. 4 is a flowchart of the simulation method according to this embodiment. Each process shown in FIG. 4 is realized as the processing unit 31 (FIG. 2) executes the program stored in the storage unit 33 (FIG. 2).

First, the shape of the wall surface 11 (FIG. 3A) of the circular tube 10 to be simulated, information that defines the fluid particles 21 (for example, the physical property values of the fluid), initial conditions, and other simulation conditions are determined. The information is input through the input unit 30. The processing unit 31 acquires shape definition data that defines the shape of the wall surface 11 of the circular tube 10 to be simulated, the information that defines the fluid particles 21, initial conditions, and other necessary simulation conditions from the input unit 30 (step S1).

The information that defines the fluid particles 21 includes, for example, the values of the fitting parameters ε_{F} and σ_{F} in Equation (5), the finite elongation nonlinear elastic potential U_{ch} (r: ε_{F}, σ_{F}) in Equation (6), the mass of particles, and the like. In this embodiment, the values of the fitting parameters ε_{W} and σ_{W} of Equation (8) are the same as the values of the fitting parameters ε_{F} and σ_{F} of Equation (5).

The initial conditions include information that defines initial values of the position and velocity of the fluid particles 21. Other simulation conditions include information on the density and gravity of the fluid for defining the body force acting on the fluid, information on a viscosity coefficient of the fluid, and the like.

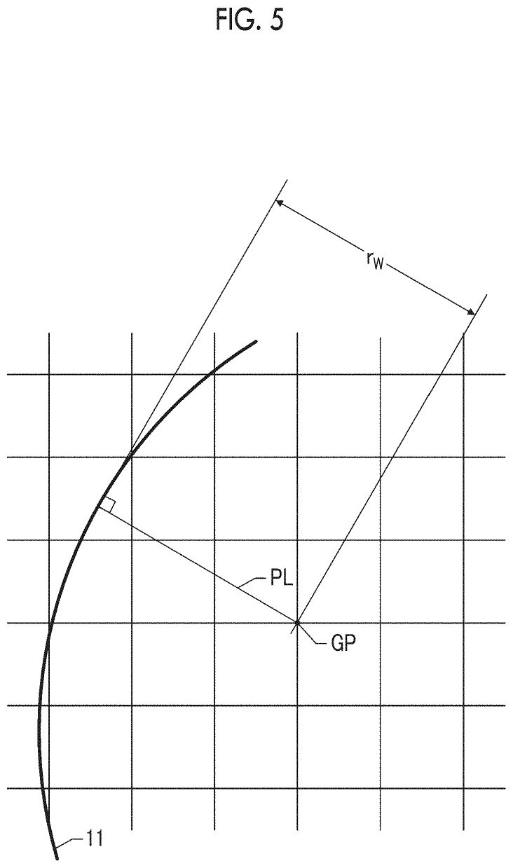

Next, a signed distance function (SDF) is generated on the basis of the shape of the wall surface 11 (step S2). The signed distance function will be described with reference to FIG. 5.

FIG. 5 is a schematic diagram for explaining a signed distance function. A space including a flow path of the fluid is divided by a three-dimensional orthogonal grid. For each of a plurality of grid points GP, a length r_{W} (that is, a distance from the grid point GP to the wall surface 11) of a perpendicular line PL drawn from the grid point GP to the wall surface 11 is made to be associated with each of the grid points GP. A positive distance is associated with the grid point GP inside the wall surface 11, and a negative distance is associated with the grid point GP outside the wall surface 11. In FIG. 5, the space is represented in two dimensions, but in reality, each grid point GP in the three-dimensional space is associated with a signed distance to the wall surface 11. Information in which each position in the space is associated with a signed distance to the wall surface 11 is called a signed distance function.

By using the signed distance function and performing an interpolation calculation as necessary, it is possible to obtain the distance to the wall surface 11 and the direction of the perpendicular line drawn on the wall surface 11 for any point in the space. In a case where the distance to the wall surface 11 and the direction of the perpendicular line are known for any point, it is possible to calculate a force received by the fluid particle 21 from the wall surface 11 on the basis of the interaction potential received from the wall surface 11.

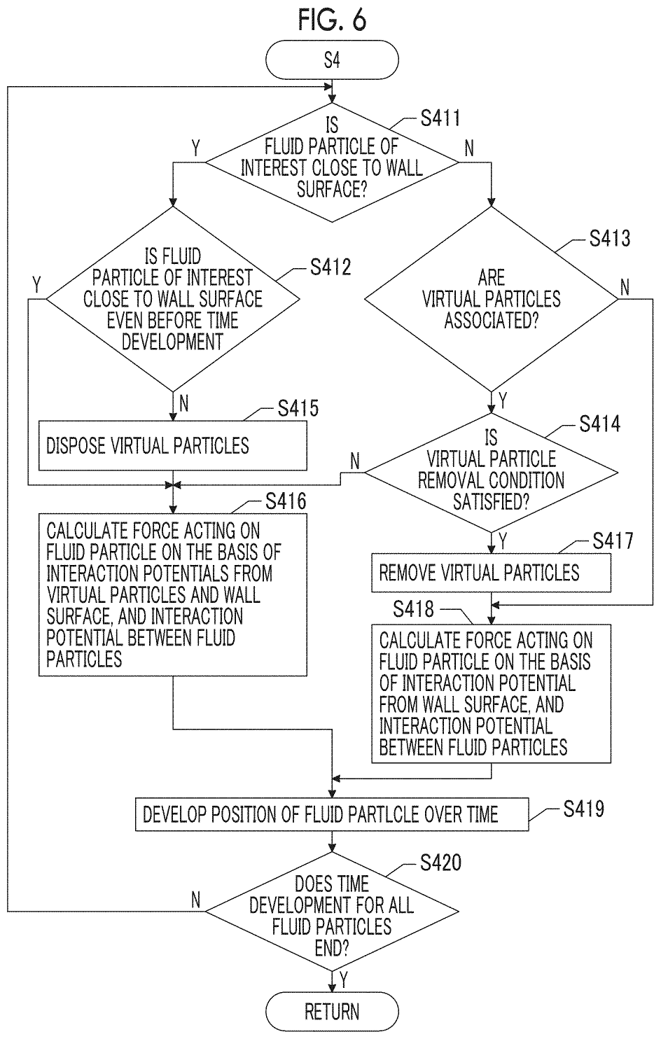

After the signed distance function is generated in step S2 of FIG. 4, a plurality of fluid particles 21 that form the plurality of polymers 20 are disposed in the space inside the wall surface 11 of the circular tube 10 (FIG. 3A) (step S3). After the plurality of fluid particles 21 are disposed, for each fluid particle 21, the position of the fluid particle 21 is developed over time by solving the equation of motion on the basis of the interaction potential acting on the fluid particles 21 (step S4). The detailed process of step S4 will be described later with reference to FIGS. 6 to 8C. The process of developing the position of the fluid particle 21 over time is repeated until analysis end conditions are satisfied (step S5). For example, in a case where a flow field reaches a steady state, it is determined that the analysis end conditions are satisfied. In a case where the analysis is ended, the analysis result is output through the output unit 32 (step S6). The output information includes, for example, information representing the velocity distribution of the fluid particles 21.

FIG. 6 is a flowchart showing the detailed process of step S4 (FIG. 4). Processes from step S411 to step S419 in FIG. 6 are executed for each of all the fluid particles 21 (step S420).

First, it is determined whether or not the fluid particle 21 of interest is close to the wall surface 11 (step S411).

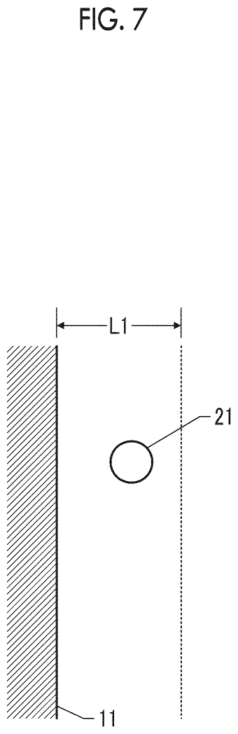

The process of step S411 will be described with reference to FIG. 7.

FIG. 7 is a schematic view showing a positional relationship between the wall surface 11 and the fluid particle 21. In a case where the distance from the fluid particle 21 to the wall surface 11 is equal to or less than a proximity determination threshold value L1, it is determined that the fluid particle 21 is close to the wall surface 11. In the present specification, the fluid particle 21 having the distance of the proximity determination threshold value L1 or less to the wall surface 11 are referred to as a “wall surface proximity particle”.

As the proximity determination threshold value L1, for example, a distance r₀ in a case where the interaction potential φ_{W} between the wall surface 11 and the fluid particle 21 shown in Equation (7) and FIG. 3C is minimized is adopted. This means that when the fluid particle 21 begins receiving a repulsive force from the wall surface 11, the fluid particle 21 is treated as a wall surface proximity particle 21A. Physically, in a case where there is no other fluid particle 21 between the fluid particle 21 to be determined and the wall surface 11, the fluid particle 21 is treated as the wall surface proximity particle 21A.

In a case where the fluid particle 21 of interest is a wall surface proximity particle, it is determined whether or not the fluid particle 21 of interest is close to the wall surface 11 even before the position of the fluid particle 21 of interest is developed over time (before the execution of the latest time step) (step S412). Before the time development, in a case where the fluid particle 21 of interest is not close to the wall surface 11, that is, in a case where the fluid particle 21 moves from a position that is not close to the wall surface 11 to a position close to the wall surface 11, due to the movement of the fluid particle 21 in the latest time step, a plurality of virtual particles are disposed in the vicinity of the fluid particle 21 of interest (step S415).

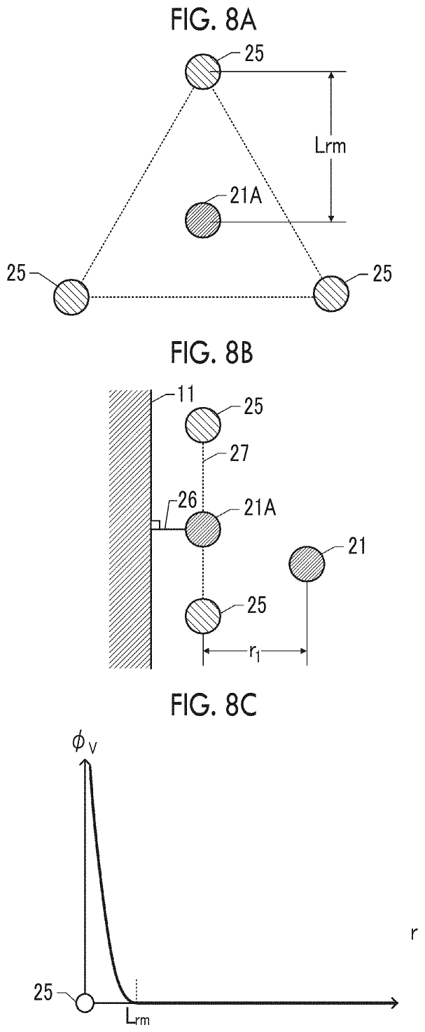

The process of arranging the virtual particles will be described with reference to FIGS. 8A to 8C.

FIG. 8A is a diagram showing a positional relationship between the wall surface proximity particle 21A and a plurality of virtual particles 25 when viewed in a direction parallel to a perpendicular line drawn from the wall surface proximity particle 21A to the wall surface 11. FIG. 8B is a diagram showing a positional relationship between the wall surface proximity particle 21A and the plurality of virtual particles 25 when viewed in a direction perpendicular to the perpendicular line 26 drawn from the wall surface proximity particle 21A to the wall surface 11.

For example, three virtual particles 25 are disposed on a virtual plane 27 that is orthogonal to the perpendicular line 26 drawn from the wall surface proximity particle 21A to the wall surface 11 and passes through the wall surface proximity particle 21A. The three virtual particles 25 are disposed at positions of three vertices of an equilateral triangle whose center of gravity is the position of the wall surface proximity particle 21A. It is assumed that the posture of the equilateral triangle with respect to the direction of rotation in the plane of the virtual plane 27 is random.

Next, an interaction potential φᵥ exerted on the wall surface proximity particle 21A by the virtual particles 25 will be described. The interaction potential φᵥ is defined as follows.

$$\begin{matrix}{φ}_{v} ( r ) = 4 {ɛ}_{v} \{ {( \frac{{σ}_{v}}{r} )}^{12} - {( \frac{{σ}_{v}}{r} )}^{6} + 0.25 \} & ( r \leq {2}^{\frac{1}{6}} {σ}_{v} ) \\ {φ}_{v} ( r ) = 0 & ( r > {2}^{\frac{1}{6}} {σ}_{v} )\end{matrix} \qquad ( 9 )$$

Here, r is a distance between the wall surface proximity particle 21A and the virtual particles 25, and εᵥ and σᵥ are fitting parameters. In a case where a constant 0.25 on the right side of the first line of Equation (9) is replaced with zero, the interaction potential φᵥ becomes the Lennard-Jones type potential.

FIG. 8C is a graph showing the interaction potential φᵥ. In a case where the distance r between the wall surface proximity particle 21A and the virtual particles 25 is less than Lᵣₘ, the wall surface proximity particle 21A receives a repulsive force from the virtual particles 25. In a case where the distance r is equal to or greater than Lᵣₘ, the wall surface proximity particle 21A receives no force from the virtual particles 25. Here, Lᵣₘ is equal to 2^{1/6}σᵥ of Equation (9). In the present specification, the distance Lᵣₘ is referred to as a “maximum repulsive force generation distance”.

In a case where the virtual particles 25 (FIG. 8A) are disposed, the distance between each of the virtual particles 25 and the wall surface proximity particle 21A is set to be equal to the maximum repulsive force generation distance Lᵣₘ. Here, at the position of the wall surface proximity particle 21A, the magnitude of the interaction potential φᵥ by the virtual particles 25 is zero. Accordingly, the energy of the entire system does not change before and after the virtual particles 25 are disposed.

Inside the equilateral triangle whose vertices are the positions of the three virtual particles 25, the interaction potential φᵥ is minimized at the position of the center of gravity of the equilateral triangle. That is, in a case where the wall surface proximity particle 21A move inside the equilateral triangle, a force for pushing the wall surface proximity particles 21A back to the position of the center of gravity acts on the wall surface proximity particles 21A. In other words, the interaction potential φᵥ by the three virtual particles 25 acts in such a direction as to prevent the wall surface proximity particles 21A from moving in the direction parallel to the wall surface 11. It is preferable to set a time step width to be small so that the wall surface proximity particles 21A do not move to the outside of the equilateral triangle due to time development of one time step.

As the interaction potential φᵥ, a potential other than the potential of Equation (9) may be adopted. For example, a potential may be adopted such that in a case where the distance from the fluid particle 21 to the virtual particles 25 is less than the maximum repulsive force generation distance Lᵣₘ, a repulsive force is generated in the fluid particle 21, and in a case where the distance from the fluid particle 21 to the virtual particles 25 is equal to or greater than the maximum repulsive force generation distance Lᵣₘ, the fluid particle 21 receives no force from the virtual particles 25.

After the virtual particles 25 are disposed in step S415 of FIG. 6, the force acting on the wall surface proximity particle 21A is calculated (step S416). The force due to the interaction potential φᵥ (FIG. 8C) from the virtual particles 25 (FIGS. 8A and 8B), the interaction potential φ_{W} (FIG. 3C) from the wall surface, and the interaction potential φ_{F} (FIG. 3B) from other fluid particles 21 acts on the wall surface proximity particles 21A. Then, the equation of motion is solved for the fluid particle 21 of interest, so that the position is developed over time (step S419).

In step S412, in a case where it is determined that the fluid particle 21 of interest is close to the wall surface 11 even before the time development, three virtual particles 25 (FIG. 8A and FIG. 8B) are already disposed in the vicinity of the fluid particle 21 of interest. Under the condition that the positions of the virtual particles 25 are fixed, the force acting on the fluid particle 21 of interest is calculated (step S416). Then, the equation of motion is solved for the fluid particle 21 of interest, so that the position is developed over time (step S419).

In a case where it is determined in step S411 that the fluid particle 21 of interest is not close to the wall surface 11, it is determined whether or not the virtual particles 25 are associated with the fluid particle 21 of interest (step S413). In a case where the fluid particle 21 of interest is not associated with the virtual particles 25, the force acting on the fluid particle 21 is calculated on the basis of the interaction potentials φ_{W} (FIG. 3C) and φ_{F} (FIG. 3B) (step S418). Then, the equation of motion is solved for the fluid particle 21 of interest, so that the position is developed over time (step S419).

In a case where it is determined in step S413 that the virtual particles 25 are associated with the fluid particle 21 of interest, it is determined whether or not the fluid particle 21 of interest satisfies a virtual particle removal condition (step S414).

The virtual particle removal condition will be described with reference to FIG. 8B. In a case where a distance r₁ from the virtual plane 27 on which three virtual particles 25 associated with the fluid particle 21 of interest are disposed to the fluid particle 21 of interest is equal to or greater than the maximum repulsive force generation distance Lᵣₘ (FIG. 8C), it is determined that the fluid particle 21 of interest satisfies the virtual particle removal condition. That is, in a case where the virtual particle removal condition is satisfied, no force acts on the fluid particle 21 of interest from any of the virtual particles 25. No that it may be determined that the virtual particle removal condition is satisfied in a case where a minimum value of the distance between the fluid particle 21 and the three virtual particles 25 is equal to or greater than the maximum repulsive force generation distance Lᵣₘ.

In a case where it is determined in step S414 that the virtual particle removal condition is satisfied, the virtual particles 25 (FIGS. 8A and 8B) associated with the fluid particle 21 of interest are removed (step S417). In a state where the virtual particles 25 are removed, the force acting on the fluid particle 21 of interest is calculated (step S418). Then, the equation of motion is solved for the fluid particle 21 of interest, so that the position is developed over time (step S419).

In a case where it is determined in step S414 that the virtual particle removal condition is not satisfied, the force acting on the fluid particle 21 of interest is calculated under the condition that the virtual particles 25 (FIGS. 8A and 8B) are disposed (step S416). Then, the equation of motion is solved for the fluid particle 21 of interest, so that the position is developed over time (step S419).

Next, excellent effects of the above embodiment will be described. In the above embodiment, a plurality of virtual particles 25 are disposed with respect to the wall surface proximity particles 21A (FIGS. 8A and 8B) close to the wall surface 11, and the virtual particles 25 give the wall surface proximity particles 21A a force for suppressing the movement in the direction parallel to the wall surface 11. Thus, in the analysis model, it is possible to reproduce a state in which the fluid does not slip in the vicinity of the wall surface 11.

Further, in the above embodiment, the signed distance function is generated on the basis of the shape of the wall surface 11. By using the signed distance function during the analysis, it is possible to easily obtain the distance from the fluid particle 21 to the wall surface 11, and the direction of the perpendicular line 26 (FIG. 8B) drawn from the fluid particle 21 to the wall surface 11.

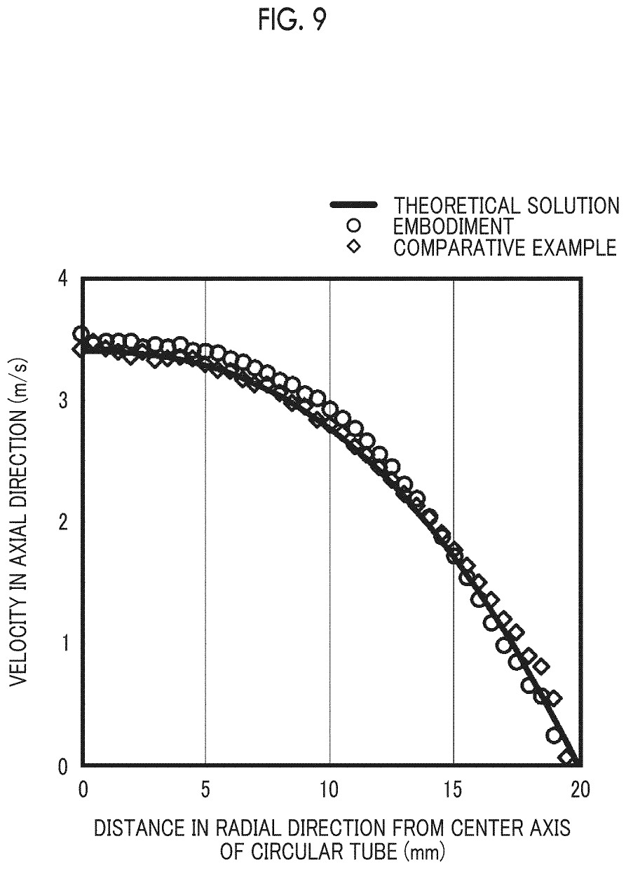

Next, a simulation result performed for confirming the excellent effects of the above embodiment will be described with reference to FIG. 9. In the simulation, the wall surface 11 (FIG. 3A) of the circular tube 10 was made into a cylinder having a radius of 20 mm and a length of 80 mm. Periodic boundary conditions were applied to both end faces in the length direction. Further, a body force in the axial direction of the circular tube 10 was applied to the fluid particle 21, and analysis was performed until an average flow velocity became 2 m/s. The Kremer Grest model was applied to the analysis of a behavior of the polymer 20.

FIG. 9 is a graph showing a simulation result in a case where a flow of a power law fluid is simulated. A horizontal axis represents a distance in the radial direction from the center axis of the circular tube 10 in the unit of “mm”, and a vertical axis represents a velocity in the axial direction of the fluid particle 21 in the unit of “m/s”. In the graph shown in FIG. 9, circle symbols indicate the result of analysis using the simulation method according to the embodiment, diamond symbols indicate the result of analysis using the simulation method according to a comparative example, and a solid line indicates a theoretical solution.

Next, the simulation method using the comparative example will be briefly described. In the comparative example, a plurality of wall surface particles are disposed along the wall surface 11 of the circular tube 10, and an interaction potential between the wall surface particles and a fluid particle is defined. A plurality of wall surface particles in a first layer are disposed along the wall surface 11 with a gap through which the fluid particle can slip between the wall surface particles. A plurality of wall surface particles in a second layer are disposed at a position deeper than the wall surface particles in the first layer so as to close the gap of the wall surface particles in the first layer.

As a fluid particle 21 enters the gap of the plurality of wall surface particles in the first layer, a non-slip state of the fluid in the vicinity of the wall surface 11 is reproduced. As the wall surface particles in the second layer close the gap of the wall surface particles in the first layer, it is possible to prevent the fluid particle 21 from penetrating the wall surface 11 and flowing outside the circular tube 10.

It can be understood that the distribution of the flow velocity obtained by the simulation method according to the embodiment matches the theoretical solution shown by the solid line. From this simulation, it was confirmed that the simulation method according to the embodiment well reproduced the non-slip state of the fluid in the vicinity of the wall surface.

Further, even in the method according to the comparative example, the non-slip state of the fluid in the vicinity of the wall surface is well reproduced. However, in the simulation method according to the comparative example, a plurality of wall surface particles should be disposed along the wall surface 11. In arranging the wall surface particles, the wall surface 11 is generally divided by a triangular mesh, and the wall surface particles of the first layer are disposed at nodes. Depending on the quality of the generated triangular mesh, there may be a case where it is difficult for the wall surface particles of the second layer to fill the gap of the wall surface particles of the first layer. In particular, in a case where a geometric shape of the wall surface 11 is complicated, the quality of the triangular mesh tends to easily deteriorate. In a case where the quality of the triangular mesh deteriorates, an algorithm for arranging the wall surface particles of the second layer so as to close the gap of the wall surface particles of the first layer becomes complicated.

In this embodiment, since it is not necessary to dispose the wall surface particles along the wall surface 11, it is not necessary to provide a complicated algorithm for arranging the wall surface particles of the second layer.

Next, a modified example of the above embodiment will be described.

In the above embodiment, the wall surface 11 (FIG. 3A) has a cylindrical shape, but the shape of the wall surface 11 is not limited to the cylindrical shape, and the above embodiment may be applied to a wall surface having a more complicated shape. Further, in the above embodiment, three virtual particles 25 (FIG. 8A) are disposed in the vicinity of the wall surface proximity particle 21A, but four or more virtual particles 25 may be disposed.

In the above embodiment, the analysis is performed using the signed distance function that defines the shape of the wall surface 11, but the shape of the wall surface 11 may be defined using other functions capable of obtaining the distance from the fluid particle 21 to the wall surface 11 and the direction of the perpendicular line drawn from the fluid particle 21 to the wall surface 11.

In the simulation for confirming the effect of the above example, the analysis is performed on the power law fluid in which the plurality of fluid particles 21 may form the polymer 20, but the above example may also be applied to analysis of a Newtonian fluid.

It is needless to say that each embodiment is merely an example and partial replacement or combination of configurations shown in different embodiments is possible. The same effects by the same configurations of the plurality of embodiments will not be described one by one for each embodiment. Furthermore, the present invention is not limited to the embodiments described above. For example, it will be apparent to those skilled in the art that various modifications, improvements, combinations, or the like can be made.

It should be understood that the invention is not limited to the above-described embodiment, but may be modified into various forms on the basis of the spirit of the invention. Additionally, the modifications are included in the scope of the invention.

What is claimed is:

1. A simulation apparatus that analyzes behaviors of a plurality of fluid particles in an analysis model in which a fluid in contact with a wall surface is represented by the plurality of fluid particles, the apparatus comprising:
an input unit through which simulation conditions including information that defines a shape of the wall surface, information that defines an interaction potential that the plurality of fluid particles receive from the wall surface, and physical property values of the fluid are input; and
a processing unit that acquires the simulation conditions input through the input unit, solves an equation of motion for the plurality of fluid particles on the basis of the acquired information, and develops positions of the plurality of fluid particles over time,
wherein the processing unit measures a fluid particle whose distance to the wall surface is equal to or less than a proximity determination threshold value among the plurality of fluid particles as a wall surface proximity particle, and generates a plurality of virtual particles at positions where the plurality of virtual particles interact with the wall surface proximity particle, fixes the positions of the plurality of virtual particles, and causes an interaction potential that prevents movement of the wall surface proximity particle in a direction parallel to the wall surface to act between the wall surface proximity particle and the plurality of virtual particles to solve the equation of motion for the wall surface proximity particle.

2. The simulation apparatus according to claim 1,
wherein an interaction potential acting between the wall surface proximity particle and each of the plurality of virtual particles has such a shape that a repulsive force increases as a distance between the particles decreases.

3. The simulation apparatus according to claim 1,
wherein the processing unit removes the plurality of virtual particles generated for the wall surface proximity particle in a case where the wall surface proximity particle moves away to a distance where the wall surface proximity particle does not receive a force from each of the plurality of virtual particles.

4. The simulation apparatus according to claim 1,
wherein in generating the plurality virtual particles, the processing unit generates the plurality of virtual particles at positions of vertices of an equilateral triangle whose center of gravity is the position of the wall surface proximity particle, on a plane that is orthogonal to a perpendicular line drawn from the wall surface proximity particle to the wall surface.

5. The simulation apparatus according to claim 1,
wherein an interaction potential acting between the wall surface proximity particle and each of the plurality of virtual particles does not cause a force to act on the particle in a case where a distance between the particles is equal to or greater than a maximum repulsive force generation distance, and causes a repulsive force to act on the particle in a case where the distance between the particles is less than the maximum repulsive force generation distance.

6. The simulation apparatus according to claim 5,
wherein in generating the plurality of virtual particles, the processing unit generates the plurality of virtual particles at positions where a distance from the wall surface proximity particle is the maximum repulsive force generation distance.

7. The simulation apparatus according to claim 1,
wherein the processing unit divides a space in which the plurality of fluid particles are disposed by an orthogonal lattice, generates a signed distance function in which each grid point is associated with the distance from the wall surface on the basis of information that defines the shape of the wall surface, and obtains distances between the plurality of fluid particles and the wall surface using the signed distance function.

8. A simulation method for analyzing behaviors of a plurality of fluid particles in an analysis model in which a fluid in contact with a wall surface is represented by the plurality of fluid particles, the method comprising:
acquiring simulation conditions including information that defines a shape of the wall surface, information that defines an interaction potential that the plurality of fluid particles receive from the wall surface, and physical property values of the fluid;
solving an equation of motion for the plurality of fluid particles on the basis of the acquired information to analyze behaviors of the plurality of fluid particles;
measuring a fluid particle whose distance to the wall surface is equal to or less than a proximity determination threshold value among the plurality of fluid particles as a wall surface proximity particle, during the analysis; and
generating a plurality of virtual particles at positions where the plurality of virtual particles interact with the measured wall surface proximity particle, fixing the positions of the plurality of virtual particles, and causing an interaction potential that prevents movement of the wall surface proximity particle in a direction parallel to the wall surface to act between the wall surface proximity particle and the plurality of virtual particles to solve the equation of motion for the wall surface proximity particle.

9. A computer readable medium storing a program that causes a computer to execute a simulation that analyzes behaviors of a plurality of fluid particles in an analysis model in which a fluid in contact with a wall surface is represented by the plurality of fluid particles, the program causing the computer to realize:
a function of acquiring simulation conditions including information that defines a shape of the wall surface, information that defines an interaction potential that the plurality of fluid particles receive from the wall surface, and physical property values of the fluid;
a function of solving an equation of motion for the plurality of fluid particles on the basis of the acquired information to analyze behaviors of the plurality of fluid particles;
a function of measuring a fluid particle whose distance to the wall surface is equal to or less than a proximity determination threshold value among the plurality of fluid particles as a wall surface proximity particle, during the analysis; and
a function of generating a plurality of virtual particles at positions where the plurality of virtual particles interact with the measured wall surface proximity particle, fixing the positions of the plurality of virtual particles, and causing an interaction potential that prevents movement of the wall surface proximity particle in a direction parallel to the wall surface to act between the wall surface proximity particle and the plurality of virtual particles to solve the equation of motion for the wall surface proximity particle.
